(19) United States
(12) Patent Application Publication
(10) Pub. No.: US 2014/0279728 A1
(43) Pub. Date: Sep. 18, 2014

(54) System and Method for Caring for a Person Afflicted with Dementia

(71) Applicant: Gary Skole, Mt. Laurel, NJ (US)

(72) Inventor: Gary Skole, Mt. Laurel, NJ (US)

(21) Appl. No.: 14/218,327

(22) Filed: Mar. 18, 2014

Related U.S. Application Data
(60) Provisional application No. 61/852,329, filed on Mar. 15, 2013.

(51) Int. Cl. G06N 5/04

(52) U.S. Cl. CPC G06N 5/04
USPC 706/11

(57) ABSTRACT

A method of preparing a customized schedule of activities for a person afflicted with dementia, the method comprising (a) prompting a user with questions regarding the person's preferred activities, (b) compiling user responses regarding the person's preferred activities, (c) prompting a user with question concerning the person's ability to perform certain tasks, (d) compiling user responses regarding the person's abilities, (e) determining the person's stage of dementia based on the user responses regarding the person's abilities, and (f) based on the stage of dementia, generating a schedule of activities, the schedule of activities including essential activities and preferred activities, wherein time allocated between the essential and preferred activities in the schedule differs for different stages, and wherein the preferred activities depends at least in part on the responses received in step (b).

### REFERENCE TO RELATED APPLICATIONS

This application claims priority to Provisional Application No. 61/852,329, filed Mar. 15, 2013, incorporated herein by reference in its entirety.

### FIELD OF INVENTION

The present invention relates to a system and method for assessing a person afflicted with dementia and generating a schedule of activities.

### BACKGROUND

Dementia is a general term that describes a decline in mental ability, which is severe enough to cause an interference in the daily life of people afflicted with it. Alzheimer's is the most common form of dementia and is often used interchangeably to describe all forms of dementia. This is a progressive disease which usually starts out in a mild stage and progresses to more advanced stages. Other common diseases associated with dementia include, for example, Creutzfeldt-Jakob Disease Dementia with Lewy Bodies, Down Syndrome, Frontotemporal Dementia, Huntington's Disease Mild Cognitive Impairment, Mixed Dementia, Normal Pressure Hydrocephalus, Posterior Cortical Atrophy, Parkinson's Disease Dementia, Traumatic Brain Injury, Vascular Dementia and Korsakoff Syndrome.

Dementia impacts many Americans. More than five (5) million Americans are living with dementia, and one in eight older Americans has dementia. Dementia is the sixth-leading cause of death in the United States and the only cause of death among the top ten (10) in the United States that cannot be prevented, cured or even slowed. Additionally, people with dementia are far more likely to have additional co-existing conditions (e.g., diabetes and heart disease), and be hospitalized for these conditions than people without dementia.

Dementia impacts not only those stricken with the condition, but also those who care for them. More than fifteen (15) million Americans provide unpaid care valued at $210 billion for persons with dementia. Unpaid caregivers, primarily family members, account for eighty percent of the care being given.

Caring for a person with dementia can be challenging due to the complexity of the disease. Consequently, people with dementia have a higher rate of hospitalization and the cost of caring for them is also greater than caring for people without dementia. Additionally, the stress, both physical and mental placed on caregivers, leads to a much higher rate of additional health problems for those caregivers themselves.

Because of the challenging nature of this disease, generally a person with advanced dementia is placed into an institution for care. However, in-home care has become a popular alternative in recent years. It is preferred by 90% of seniors compared to being placed into an institutional setting. Furthermore, managed health care has made attempts to keep people out of nursing homes due to the higher costs.

Caring for people with dementia in the home has many challenges as mentioned above. Furthermore, caregivers often do not have the appropriate knowledge of the disease and lack the tools required to provide optimal care. For example, studies have shown that people with dementia require consistent daily routines, comprising activities, which are not only interesting to the afflicted person, but also capable of being performing by that person. In a dementia specific nursing home, a daily regiment is followed strictly. However, one problem with in-home care is that it tends to lack this type of structured routine. Even if a routine can be maintained, it is often difficult to tell when the activities need to be adapted to match the level of dementia as it advances.

Another problem with in-home care is that additional co-existing conditions such as diabetes, heart disease, COPD and other diseases are often much harder to care for and cause additional problems due to a lack of compliance. For example, a person with dementia who also has diabetes tends not to check their blood sugars regularly or visit the doctor regularly to have their eyes or feet examined, thus complicating their condition.

Lastly, even with the best care, problems will still occur. Unfortunately, due to the nature of the disease, the afflicted individuals are often unable to communicate their troubles, which often leads to agitation or exacerbates illnesses.

Therefore, a need exists for a tool that helps home caregivers assess the condition of a patient and prepare schedule of meaningful activities based on their condition. The present invention fulfills this need among others.

### SUMMARY OF INVENTION

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to the more detailed description that is presented later.

The present invention relates to a system and method for assessing a person afflicted with dementia and generating a schedule of activities. In one embodiment, the system and method of the present invention gathers detailed information which takes into account the person's past interests, current interests, current ability level, and optionally co-existing conditions, determines the person's stage of dementia, and then generates a daily schedule which is created to provide a balanced, structured day filled with activities which are appropriate for the individual based on their lifestyle, personality and stage of dementia. In one embodiment, the schedule is modified based on the results of ongoing stage determination assessment. These modifications may include changing the concentration of different activities. For example, a person who is assessed to be at stage four will have activities which may include 30% productive activities, while a person who is assessed to be a stage one may have no productive activities built into their schedule. In one embodiment, the person's quality of life is also assessed to determine aspects of the person's life that need improvement, and those aspects in which the person is happy. This assessment is then used to modify the schedule to maximize the person's quality of life. The schedule might also take into account other diseases that afflict the individual, and build appropriate activities such as blood pressure measurement, exercise, etc. into the schedule. In one embodiment, the system also provides reminders to alert caregivers of doctors appointments and time sensitive activities in order to help maintain compliance.

Accordingly, one aspect of the invention is a method of preparing a customized schedule of activities for a person afflicted with dementia. In one embodiment, the method comprises: (a) prompting a user with questions regarding said person's preferred activities; (b) compiling user responses regarding said person's preferred activities; (c) prompting a user with question concerning said person's ability to perform certain tasks; (d) compiling user responses regarding said person's abilities; (e) determining said person's stage of dementia based on said user responses regarding said person's abilities; and (f) based on said stage of dementia, generating a schedule of activities, said schedule of activities including essential activities and preferred activities, wherein time allocated between said essential and preferred activities in said schedule differs for different stages, and wherein said preferred activities depends at least in part on said responses received in step (b).

Another aspect of the invention is a system for preparing a customized schedule of activities for a person afflicted with dementia. In one embodiment, the system comprises a digital processor, memory operatively connected to said processor, and a display, said memory being configured with instructions for instructing said processor to execute the following steps: (a) prompting a user with questions regarding said person's preferred activities; (b) compiling user responses regarding said person's preferred activities; (c) prompting a user with question concerning said person's ability to perform certain tasks; (d) compiling user responses regarding said person's abilities; (e) determining said person's stage of dementia based on said user responses regarding said person's abilities; and (f) based on said stage of dementia, generating a schedule of activities, said schedule of activities including essential activities and preferred activities, wherein time allocated between said essential and preferred activities in said schedule differs for different stages, and wherein said preferred activities depends at least in part on said responses received in step (b).

Yet another aspect of the invention is software for preparing a customized schedule of activities for a person afflicted with dementia. In one embodiment, the software comprises a computer readable medium comprising instructions for instructing a processor to execute the following steps: (a) prompting a user with questions regarding said person's preferred activities; (b) compiling user responses regarding said person's preferred activities; (c) prompting a user with question concerning said person's ability to perform certain tasks; (d) compiling user responses regarding said person's abilities; (e) determining said person's stage of dementia based on said user responses regarding said person's abilities; and (f) based on said stage of dementia, generating a schedule of activities, said schedule of activities including essential activities and preferred activities, wherein time allocated between said essential and preferred activities in said schedule differs for different stages, and wherein said preferred activities depends at least in part on said responses received in step (b).

### BRIEF DESCRIPTION OF DRAWINGS

FIG. 1 shows a flow chart for one embodiment of the present invention.

FIG. 2 shows a screenshot corresponding to step 101 of the screenshot of FIG. 1.

FIGS. 3a-3e are screenshots corresponding to step 102 of the screenshot of FIG. 1.

FIG. 4 shows a screenshot corresponding to step 104 of the screenshot of FIG. 1.

FIGS. 5a-5d show activity pyramids corresponding to pyramid 400 shown in FIG. 1.

FIG. 6 shows a screenshot corresponding to step 105 of the flowchart of FIG. 1.

FIG. 7 shows a screenshot of essential activities.

FIG. 8 shows a screenshot corresponding to productive activities.

FIG. 9 shows a screenshot corresponding to step 106 of the flowchart of FIG. 1.

FIG. 10 shows a screenshot corresponding to step 107 of the flowchart of FIG. 1.

FIG. 11a shows questions regarding the patient's quality of life.

FIG. 11b shows a screenshot of a report generated based upon the input from the screenshot of FIG. 11a.

FIG. 12a shows a screenshot corresponding to step 109 of the flowchart of FIG. 1.

FIG. 12b shows a screenshot responsive to the input received from the screenshot of FIG. 12a.

FIG. 13 shows a screenshot corresponding to step 110 of the flowchart of FIG. 1.

FIG. 14 shows detail of the QOL score of FIG. 13.

FIG. 15 shows a screenshot of a care manager report of FIG. 13.

FIG. 16 shows one embodiment of the system of the present invention.

### DETAILED DESCRIPTION

Referring to FIG. 16, a schematic of the system 1600 is shown. The system 1600 comprises at least a central processor unit (CPU) 1601 and memory 1602 operatively connected to the CPU 1601. The system 1600 may be configured to facilitate processing at one or more processor units, and that the CPUs need not reside in a single computer, nor at a single physical site. Once the CPU processes the information, the memory 1602 stores the results. The system 1600 may also include a data storage component 1603 for storing information associated with the aforementioned process and product selections.

In one embodiment, the CPU 1601 is a server networked with a user computer 1610 as shown in FIG. 16. Although the system 1600 is connected to the user computer 1610 over a network 1604 in a server/client configuration as shown in FIG. 16, it should be understood that any known networking configuration can be used such as peer-to-peer or cloud computing. On the user side, the user computer 1610 comprises a processing unit 1605, a display 1606, and a user interface 1607. The user interface may comprise traditional equipment such as a keyboard and mouse for entering information, as well as more exotic equipment such as scanners, voice recognition systems, touch screens, and 3D graphics displays. It is anticipated that system 1600 can be configured to accommodate any user interface both known and in the future.

Rather than having a networked system, the system may comprise a stand alone computer comprising a digital processor, memory operatively connected to the processor, a display screen operatively connected to the processor through known circuitry/drivers. Suitable systems include, for example, tablet computers such as the iPad and other similar tablets, as well as desktop or laptop computers. Still other systems are possible and will be obvious to those of skill in the art in light of this disclosure.

The memory 1602 is configured with instructions for instructing the processor(s) to execute steps to assess a person's stage of dementia and to generate a schedule of activities. In one embodiment, the process comprises the following steps: (a) prompting a user with questions regarding the person's preferred activities; (b) compiling user responses regarding the person's preferred activities; (c) prompting a user with question concerning the person's ability to perform certain tasks; (d) compiling user responses regarding the person's abilities; (e) determining the person's stage of dementia based on the user responses regarding the person's abilities; and (f) based on the stage of dementia, generating a schedule of activities, the schedule of activities including essential activities and preferred activities, wherein time allocated between the essential and preferred activities in the schedule differs for different stages, and wherein the preferred activities depends at least in part on the responses received in step (b).

In one embodiment, there are two main components or modules to the system of the present invention. The first is a stage determination module to help determine the current stage of dementia. This module comprises functionality to prompt the user with a series of questions. An algorithm is then used to determine what stage of dementia the person is in. In one embodiment, there are four stages of dementia with four representing the earlier stages of the disease, and one represents the most advanced stage.

The second module is a scheduling module. In this module, a different set of questions is asked of the user/caregiver which includes the person's past and recent history, likes, hobbies and health information. Another algorithm then utilizes this information to create a meaningful schedule of activities to have a balanced day. In one embodiment, these activities are categorized in five different categories—namely, essential, productive, wellness, enjoyment and recuperative. Depending on the person's stage of dementia, a schedule is generated in which the balance among the different activity categories is varied so that a person at stage four might have a different concentration of the five categories than a person at stage one. In one embodiment, the stage assessment is repeated regularly, and the schedule is then modified accordingly.

Additionally, in one embodiment, the system captures information about co-existing conditions, such as high blood pressure or diabetes. If additional activities would be beneficial for the particular condition, they are entered into the daily schedule. Alerts are also sent out via email to the appropriate people in order to increase compliance of time sensitive activities such as doctors visits. These reminders are based on generally accepted standards of care.

In one embodiment, to determine the effectiveness of the scheduling, a Quality of Life assessment is performed periodically. A series of questions is asked which are based on the most recent schedule to determine whether the scheduled activities are causing positive or negative experience. These questions are crafted to establish behavior patterns and flush out problem areas. Based on the results of the QOL, the schedule is adjusted. Additionally, in one embodiment, the program provides solutions to common problems.

Referring to FIG. 1, a flowchart 100 of one embodiment of the process of the present invention is shown. In step 101, an overview of the person is provided. The purpose of this step is to provide the user with basic information about the person, including, for example, the current level of dementia, the quality of life (QOL) score, and recent notes on the person. Although this information can be provided to the user in a variety of different ways, one embodiment is shown in the screenshot 200 of FIG. 2. As shown, in portion 201 of the screenshot 200, a summary of the person's name, the stage of dementia and the quality of life score is displayed. In portion 202, a history of the stage determination is provided, and, in portion 203, an input is provided for the user to provide notes or otherwise annotate the condition of the patient.

In step 102 of the process 100 shown in FIG. 1, the user updates the condition of the person. The purpose of this step is to prompt the user to monitor and document the person's condition in a systematic way based on criteria that has been found to be indicative of the person's condition and general wellbeing. For example, referring to FIGS. 3a through 3e, screenshots 300 through 305 are shown, respectively. In the embodiment shown, the update information is broken into five different categories—namely, basic information, vital information, lifestyle information, medical/mental status and summary/special instructions. Although the patient's condition and status have been broken into these five categories in this embodiment, it should be understood that categories can be added or withdrawn, or otherwise reconfigured or modified according to a particular user's needs and preferences. In screenshot 300 show in FIG. 3a, basic information of the person is provided including name, weight, date of birth for example. In the screenshot 301 shown in FIG. 3b, vital information is displayed and presented for editing. This information includes, a primary diagnosis, secondary diagnosis and other vital information such as the person's temperature, blood pressure and pulse.

In screenshot 302 shown in FIG. 3c, detailed information about the person's lifestyle is obtained. This includes very detailed questions about their life as a child and adult including their extended family, interests, work and diet. This information is used to create a report that aids the caregiver in dealing with a person who may be mentally living at a time when they were much younger. When a question is relevant to the person, a “yes” button is checked which allows for a more detailed narrative to be taken. In screenshot 303 shown in FIG. 3d, information is taken which gathers the person's functional limitations, activities permitted and any special equipment they may be using. This helps the care-manger create a plan of care for the person. In screenshot 304 found in FIG. 3e, information is gathered about the person's mental status that may include if the person is forgetful, depressed, agitated, lethargic or other mental status.

In step 103, basic information is gathered about the person's contacts. These contacts can be placed in order of importance and the information gathered may include name, address, phone number and email addresses.

In step 104 of the process 100 shown in FIG. 4, the system determines the person's current stage of dementia. The purpose of this step is to determine the person's current level of dementia based on a series of questions. This process is done on a regular basis to determine if the progression of the disease has caused the person to move into a more advanced stage of the disease. The stages used range from the lowest functioning level represented by Stage 1 up to the highest functioning level represented by Stage 4. As shown in portion 401 of screenshot 400, an algorithm calculates the score based on the answers to specific questions based on the person's current abilities. Each question is given a score, with some questions weighted more than others and then an average of the totals is used to generate the score. This score is then rounded to determine the current stage as shown in portion 402. Although this algorithm essentially averages the results to determine the state, other algorithms could be used and would be obvious to one of skill in the art in light of this disclosure. For example, rather than simply averaging the results, the results could be weighted to emphasize the relative importance of some questions over other. For example, in one embodiment, the ability of the person to communicate orally may be deemed more important than their cognitive ability to know the day of the week. In such an embodiment, communication skill will be weighed more than the cognitive ability. In yet another embodiment, the stages are divided into two separate categories that include the current cognitive and physical levels of the person. As before, a lower functioning level is represented by a Stage 1 and a higher functioning level is a Stage 4. As an example, using this method, a person who is cognitively the lowest function but physically the highest function would receive a score of 1-4.

Screenshot 404 shown in FIG. 5a represents the AlzBetter Activity Pyramid. Once each stage has been determined, an associated activity pyramid accompanies it. The purpose of the pyramid is to create the structure for a balanced day filled with the appropriate activities according to the client's current level of dementia. In the level 4 pyramid as seen in screenshot 407, it is anticipated that there will be a slightly lower amount of time spent on essential activities (50 percent) as clients are better able to care for themselves. A large part of their day is made up of enjoyment, productive and wellness activities (35 percent) and a relatively smaller part of the day is comprised of recuperative activities (15 percent), as they are more mobile and capable of being active. The level 3 pyramid as seen in screenshot 406 maintains approximately the same amount of essential activities as level 4 (50 percent) but we see a slight increase in the recuperative activities as the client begins to slow down. In level three, there is a balance of all four non-essential activities of 50 percent. The level 2 pyramid is shown in screenshot 405 and shows a slight increase in need for more time spent on essential activities (55 percent) and a decrease in productive and wellness activities (15 percent). A combination of recuperative and enjoyment activities makes up the balance of the day (30 percent). As the client progresses with the disease, essential activities become more difficult and take up a larger portion of the day (60 percent). Recuperative activities make up the next largest part of the day (22 percent) followed by enjoyment activities (15 percent) and very little productive or wellness activities (3 percent). The breakdown reflected here is tied into the daily schedule of actual activities created in a later part of the program. The breakdown of activities can also be altered to fit different client's needs.

In step 105 of the process 100 as shown in FIG. 6, the user investigates various activities for the person. The purpose of this step is to determine the person's interests in various activities and the importance of the activities in their daily life. Additionally, this step is used to help determine where those activities fit into the daily schedule of the person with dementia. This step is important because people with dementia perform better when their day is scheduled and when the schedule is based upon their interests as well as prior lifestyle. Any deviation from this can cause increased confusion, agitation and a host of other problematic behaviors.

As shown in screenshot 500, the user has a choice of various activity categories. In this embodiment, five categories are used, which include Essential, Productive, Enjoyment, Wellness and Recuperative. Each activity group has a separate set of questions designed to help populate a balanced, daily schedule based on the person's personalized activities. Essential activities could include washing hair, oral care, dressing, sleeping, eating, drinking, toileting and bathing as well as other miscellaneous activities deemed to be essential. Productive activities are those which make the person feel smart, useful and strong and may include work, organizing, and fixing things. Enjoyment activities are those that are fun and enjoyable for the person such as hobbies, singing, dancing, playing games and getting together socially. Wellness activities are those that promote cognitive and physical wellness. This can include physical exercise such as walking or other exercise and mentally stimulating activities such as puzzles, board games and bingo for example. Recuperative activities are those that help a person relax and recover, both physically and mentally such as sitting on a porch swing, listening to calming music, napping and getting a massage. Although the patient's condition and status are divided among these five categories in this embodiment, it should be understood that categories can be added or withdrawn, or otherwise reconfigured or modified according to a particular user's needs and preferences.

In one embodiment, these activities are scheduled in a primary and secondary schedule. The primary schedule comprises activities that are performed in the regular course of the day, why the secondary schedule comprises alternative activities if the primary activities are not possible/convenient or otherwise not appropriate/desirable. The scheduling of these activities is based on an algorithm that weighs the relative importance of the activities and determines which belong on the Primary Schedule and which belong on the Secondary Activities List. For example, in one embodiment, Essential activities are give an importance rating of 5 and therefore are always include in the primary schedule. Non-essential (Productive, Wellness, Enjoyment and Recuperative) activities can have an importance rating of 1-4, with 4 being more important. If an activity has an importance rating of 4, it is placed onto the primary schedule unless it does not have an associated time, where it would then be placed onto the secondary activities list. Activities with an importance rating of 3 are also placed onto the primary activities schedule as long as there are available time slots available and it has and associated time. If there are no available times or there are is no time associated with the activity, then it is placed onto the secondary activities list. Items with an importance rating of 1 or 2 are automatically placed onto the secondary activities list. It should be understood that this is just one example of how an algorithm may schedule different activities having different priorities. Other algorithms can be used to practice the present invention. For example, rather than a rating system of 1-5 for each activity, the activities might be prioritized based on the category of activity—i.e., productive, recuperative, etc. Still other prioritization approaches will be obvious to one of skill in the art in light of this disclosure.

FIG. 7 shows screenshot 501. This is an example of an Essential activity, and shows how a reminder to drink fluids is scheduled. This screenshot shows that we need to remind the person in the early afternoon as well as the early evening. Each fifteen minute increment is deducted from the available slots of time as shown by the units of time available. The information captured here is then used to populate the primary schedule along with the other Essential Activities according to the time of day selected.

Screenshot 502 as shown in FIG. 8 shows a Productive Activity. This screenshot demonstrates selecting an activity such as fixing things. The user here would select the time of day, length of time for the activity as well as the importance and an accompanying narrative. The user can select from a number of predetermined activities or add activities of their own preference. The Enjoyment, Wellness, and Recuperative activities screens have a similar format and algorithm but utilize questions more appropriate to each subject. While we have chosen to break down the activities into five categories, this process could easily be modified to use only one category called “Activities” or even two categories such as Essential and Preferred Activities.

In step 106 of the process 100 shown in FIG. 9, the user views an editable version of the primary schedule. The purpose of this step is to view the primary schedule that has been created and make any changes prior to finalizing. The primary schedule is made up of activities that are most meaningful to the person and important to attempt to fit into their daily schedule. Questions that have been answered during step 105 of the process are calculated using an algorithm to determine which activities are placed into the schedule and at what times. As shown in portion 601, the program compares the current schedule against the recommended levels as was seen in the Activity Pyramids, FIG. 5a through 5d. The user can use this guide to make adjustments in an attempt to make the day as balanced as possible. Once completed, this schedule can be printed on paper or displayed on a computer or other mobile device. While it is felt that a balanced day is preferable, the schedule can be created without the use of various categories and based solely on the person's interests, desires and abilities.

In step 107 of the process 100 shown in FIG. 10, the user views an editable version of the secondary activities. The purpose of this step is to provide a list of activities that are of interest to the person, but either not at a level of importance to be on the primary schedule or are not done at a specific time of day. By having this schedule, it gives the caregivers the flexibility to deviate from the primary schedule but still work with activities that are meaningful to the person. An example of this may be a day where the primary schedule contains “walking” as an activity to be performed during the Early Afternoon time slot. However, if the weather is bad or the person is not feeling up to walking, they may go to the secondary activities list and substitute another activity that the person is more agreeable to and perform that activity instead. When a person has dementia, flexibility is of utmost importance and this secondary list provides that source of flexibility.

In step 108 of the process 100 shown in FIG. 11a, the user records the person's Quality Of Life. The purpose of this step is to attempt to capture the way the person feels about the activities programmed into their primary schedule. One of the more significant problems facing a person has dementia is their inability to communicate how they are feeling. This lack of communication leads to many behavioral problems. The system of the present invention uses an observational technique to study the reaction of the person while they perform the activities on their schedule. Based on the outcomes, certain parts of the program may be changed or addressed. As seen in the embodiment on screenshot 800, the Quality Of Life tool has all of the activities of the primary schedule listed. The caregivers use an observational technique to rate each activity either extremely negative, negative, neutral, positive or extremely positive. Depending on the type of activity and the level of dementia, each score is weighted and then an algorithm is used to total the scores up. To achieve the results, a score of −2 is generated for an extremely negative input, −1 for a negative input, 0 for a neutral input +1 for a positive input and +2 for an extremely positive input. These score are weighted depending on the current level of dementia, so that if a person is in stage 1, a neutral score is actually counted as a +1. Additionally, essential activities receiving a neutral input would also receive a +1 for all levels.

In the embodiment seen in screenshot 801, a report is generated based on the answers. This report shows patterns of behaviors both positive and negative. These patterns can be used to determine if changes are required to the activities in the primary schedule. An example of this is shown in screenshot 802 on FIG. 11b. The activity of washing hair has a negative score. If we see this same negative score repeatedly, then an action can be taken to address this issue, such as better training in bathing techniques for the caregiver, or replacing a shower with a dry shampoo. If it is a non-essential activity that is receiving a negative score, another activity can be substituted in its place.

In step 109 of the process 100 shown in FIG. 12a, the system provides the user with an interface to address certain problematic behaviors. The purpose of this step is to assist the user in trying to determine the causes of certain problematic behaviors. Again, people with dementia often have difficulty communicating when something is bothering them, which often leads to problematic behaviors. This section looks at some of the more common behavioral issues and examines some of the more common reasons for these problems. The embodiment seen in screenshot 900 shows a listing of the common problematic behaviors listed. The user selects the observed problem behavior by clicking in the circle.

In FIG. 12b, the embodiment seen on screenshot 901 shows a sample of the different options a user can select to help them discover a possible cause of the problematic behavior. In one embodiment, the user can view a video of the related problem as shown in screenshot 902. Once the potential causes have been selected, the user is taken to another page as shown in screenshot 903. The embodiment here shows the selected problems with their accompanying solutions. The problems along with their solutions can be printed out or viewed from a computer or mobile device.

In Step 110 of process 100 shown in FIG. 13, the user is able to view data in a report form as shown in screenshot 1000. As shown, there are two sets of reports available to the user—i.e., Client Reports and Care Manager Reports. A summary of the two types of reports are exhibited. The Client Reports provide a snapshot into the person's history, vital information and other important information that can provide needed information when providing care. This may be important because the person (in most instances) is not able to communicate even the most basic of information to the caregiver.

In addition to this personal person health information, as shown in portion 1001 of screenshot 1000, there is also the ability to view the QOL score. This is shown in FIG. 14 screenshot 1101. This report shows the most recent QOL score for each category as well as a total score.

As shown in portion 1002 of screenshot 1000, we are also able to see a history of the Problems & Solutions that were utilized for the person. This is a convenient tool for a caregiver or someone looking back over the history of the person, to see specific areas where additional information was requested through the AlzBetter program. This report immediately illustrates areas of past concern and educates the caregiver on what to expect with this person.

As seen in FIG. 15, we have the Care Manager Reports. With the Care Manager reports, we are able to query a specific date range for the collected data. In screenshot 1200, there is a drop down list to choose from the type of report the Care manager would like to view. In this embodiment, the types of reports available to the Care Manager include QOL, Notes, and recent events (hospitalizations, ER visits, Falls, and medication changes). Once a report is identified by the Care Manager, a date range is then selected. By viewing this information in this format, it provides the Care Manager with an overview of what transpired over a set period of time. For example, in screenshot 1201, an embodiment of a QOL report for a 60 day date range is shown. By viewing the historical record of the person's QOL scores, it identifies trends, areas of enjoyment/frustration and ultimately can influence the primary schedule of the person based upon this data. For example, if a consistently low QOL score in a particular activity is observed, the activities in that category can be adjusted until an improvement is noted.

It should be understood that the foregoing is illustrative and not limiting and that obvious modifications may be made by those skilled in the art without departing from the spirit of the invention. Accordingly, the specification is intended to cover such alternatives, modifications, and equivalence as may be included within the spirit and scope of the invention as defined in the following claims

What is claimed is:

1. A method of preparing a customized schedule of activities for a person afflicted with dementia, said method comprising:
(a) prompting a user with questions regarding said person's preferred activities;
(b) compiling user responses regarding said person's preferred activities;
(c) prompting a user with question concerning said person's ability to perform certain tasks;
(d) compiling user responses regarding said person's abilities;
(e) determining said person's stage of dementia based on said user responses regarding said person's abilities; and
(f) based on said stage of dementia, generating a schedule of activities, said schedule of activities including essential activities and preferred activities, wherein time allocated between said essential and preferred activities in said schedule differs for different stages, and wherein said preferred activities depends at least in part on said responses received in step (b).

2. The method of claim 1, wherein said schedule is adjusted periodically.

3. The method of claim 1, wherein time scheduled for said essential activities increases as said person's stage of dementia becomes worse.

4. The method of claim 1, wherein time scheduled for said preferred activity category decreases as said stage of dementia becomes worse.

5. The method of claim 1, wherein said essential and preferred activities are categorized as follows: essential, wellness, productive, enjoyment and recuperative.

6. The method of claim 5, wherein said preferred activities include preferred productive, enjoyment, wellness and recuperative activities.

7. The method of claim 1, wherein said schedule always includes essential activities.

8. The method of claim 1, further comprising:
prompting a user with questions regarding said person's quality of live; and
compiling user responses regarding quality of life and generating a quality of life indicator.

9. The method of claim 8, further comprising:
modifying said schedule based on said user responses regarding quality of life to increase said quality of life indicator.

10. The method of claim 9, wherein modifying said schedule based on said user responses regarding quality of life comprises increasing said preferred activities and reducing said essential activities.

11. The method of claim 10, further comprising:
Reiterating steps (e) and (f) periodically to generate a revised schedule.

12. The method of claim 1, further comprising:
Reiterating steps (e) and (f) periodically to generate a revised schedule.

13. The method of claim 1, further comprising:
prompting a user with questions regarding one or more co-existing conditions;
compiling user responses regarding one or more co-existing conditions; and
including in said schedule supplemental activities for said co-existing conditions.

14. The method of claim 13, wherein said co-existing conditions include at least one of diabetes, Parkinson's disease, or high blood pressure.

15. The method of claim 1, wherein preferred activities includes past and current interests and activities.

16. The method of claim 1, wherein said schedule displays reminders.

17. A computer-readable medium comprising instructions for instructing a processor operatively connected to a user interface to execute the following steps:
(a) prompting a user with questions regarding said person's preferred activities;
(b) compiling user responses regarding said person's preferred activities;
(c) prompting a user with question concerning said person's ability to perform certain tasks;
(d) compiling user responses regarding said person's abilities;
(e) determining said person's stage of dementia based on said user responses regarding said person's abilities; and
(f) based on said stage of dementia, generating a schedule of activities, said schedule of activities including essential activities and preferred activities, wherein time allocated between said essential and preferred activities in said schedule differs for different stages, and wherein said preferred activities depends at least in part on said responses received in step (b).

18. A system operatively connected to a user interface and comprising a digital processor, memory operatively connected to said processor and, said memory being configured with instructions for instructing said processor to execute the following steps:
(a) prompting a user with questions regarding said person's preferred activities;
(b) compiling user responses regarding said person's preferred activities;
(c) prompting a user with question concerning said person's ability to perform certain tasks;
(d) compiling user responses regarding said person's abilities;
(e) determining said person's stage of dementia based on said user responses regarding said person's abilities; and
(f) based on said stage of dementia, generating a schedule of activities, said schedule of activities including essential activities and preferred activities, wherein time allocated between said essential and preferred activities in said schedule differs for different stages, and wherein said preferred activities depends at least in part on said responses received in step (b).

19. The system of claim 18, wherein said user interface is selected from a tablet computer, a personal computer, or a smart phone.

20. The system of claim 19, wherein said system is operatively connected to said user interface over a network.

21. The system of claim 18, wherein said user interface is a display screen and input and wherein said system is physically integrated with said user interface.
